(19) United States
(12) Patent Application Publication
(10) Pub. No.: US 2024/0183704 A1
(43) Pub. Date: Jun. 6, 2024

(54) METHOD AND ASSEMBLY FOR DETERMINING CONTAINER WEIGHT

(71) Applicant: Cindicium Pte Ltd, Forum (SG)

(72) Inventors: David Robin BEAN, New South Wales (AU); David MCNAUGHT, Forum (SG)

(73) Assignee: Cindicium Pte Ltd, Forum (SG)

(21) Appl. No.: 18/284,846

(22) PCT Filed: Mar. 31, 2022
(86) PCT No.: PCT/SG2022/050184

§ 371 Date: Sep. 28, 2023

(30) Foreign Application Priority Data
Mar. 31, 2021 (AU) 2021900950

(51) Int. Cl. G01G 19/14; G01G 21/28

(52) U.S. Cl. CPC G01G 19/14; G01G 21/28

(57) ABSTRACT

A container lifting and weighing assembly for determining a weight of a container, the assembly having: a frame for supporting a container, the frame being connectable to a support surface to transfer a weight of the container from the container to the support surface; a lifting structure locatable between the container and the support surface, the lifting structure having one or more movable actuators and a load sensor, the lifting structure being movable between: a rest position, wherein the load path from the container to the support surface does not traverse the lifting structure; and a weighing position, wherein the lifting structure lifts the container such that the load path from the container to the support surface traverses the lifting structure, wherein, in the weighing position, the load sensor is adapted to provide a load sensor signal indicative of the weight of the container.

### FIELD

The present invention relates to a method and assembly for determining a weight of a container.

### BACKGROUND

In shipping logistics of intermodal containers, each container is shipped with a declared weight, being the weight the shipper declares the container to have. Frequently, the declared weight does not match the actual weight of the container. When the declared weight is higher than the actual weight, it is known as over declaration, when the declared weight is lower than the actual weight, it is known as under declaration. This discrepancy, when significant enough and frequent enough can have serious consequences in terms of safety and revenue.

Inadvertent misloading of container vessels, because the actual weight is different from the declared weight, can cause instability of the vessel and/or instability of the container stack, leading to loss of goods and potentially life. This risk is caused by both over and under declared containers, due to the changes in centre of gravity of the vessel and container stacks. Overdeclared containers cause inefficiencies and create safety risks, as the vessel is typically loaded on the basis of the declared weights.

The possibility exists to weigh each container, however this is practically undesirable due to the time and cost involved. Existing container handling equipment in port usually includes load-measuring equipment, however the load cells that are used in this type of equipment cannot be reliably maintained in calibration. Further, variability in friction and operator style between handling equipment, or of a particular equipment over time, causes the reading of the load-measuring equipment on handling devices to be too inaccurate for commercial use.

### SUMMARY OF INVENTION

It is an object of the present invention to address or overcome one or more of the above disadvantages, or at least provide a useful alternative to the above-mentioned methods of determining a weight of a container.

In a first aspect, the present invention provides a container lifting and weighing assembly for determining a weight of a container, the assembly having:
a frame for supporting a container, the frame being connectable to a support surface to transfer a weight of the container from the container to the support surface;
a lifting structure locatable between the container and the support surface, the lifting structure having one or more movable actuators and a load sensor, the lifting structure being movable between:
   a rest position, wherein the load path from the container to the support surface does not traverse the lifting structure; and
   a weighing position, wherein the lifting structure lifts the container such that the load path from the container to the support surface traverses the lifting structure,
wherein, in the weighing position, the load sensor is adapted to provide a load sensor signal indicative of the weight of the container.

Preferably, the lifting structure is further movable to and from:
a calibrating position, wherein the movable actuators lift the lifting structure to an extension beyond the weighing position,
wherein the load sensor signal in the calibrating position is a zero signal.

Preferably, the extension is a maximum extension of the movable actuator.

Preferably, the movable actuators include hydraulic actuators.

Preferably, the assembly, when the lifting structure is in the rest position, has dimensions of, or slightly more than, 12.01 metres×2.35 metres×2.38 metres.

Preferably, the assembly has dimensions of about 12.01 metres length and 2.35 metres width.

In a second aspect, the present invention provides a method of estimating a weight of an intermodal container using a weighing system, the weighing system including:
a second weighing device that is more likely to experience a shock load and is adapted to provide a second weight signal indicative of the weight of the container when weighed by the second weighing device; and
a processor adapted to receive the first and second weight signals, the method including the steps of:
weighing the container with the second weighing device to determine a second weight;
determining, using the processor, based on a calibration function that relates the second weight to an estimated weight, the estimated weight,
wherein the estimated weight is closer to an actual weight of the container than the second weight.

Preferably, the weighing system further includes:
a first weighing device adapted to provide a first weight signal indicative of a weight of the container when weighed by the first weighing device, and wherein the method further includes the steps of:
determining, using the processor, if a difference between the estimated weight of the second container and a declared weight of the second container exceeds a predetermined magnitude, and
if the difference exceeds the predetermined magnitude, weighing the second container with the first weighing device to determine a first weight.

Preferably, the method further includes the step of:
adjusting, using the processor, the calibration function based on the first weight of the second container determined by the first weighing device and the second weight of the second container determined by the second weighing device.

In a third aspect, the present invention provides a method of estimating a weight of a plurality of intermodal containers using a weighing system, the weighing system including:
a first weighing device adapted to provide a first weight signal indicative of a weight of the container when weighed by the first weighing device;
a second weighing device that is more likely to experience a shock load and is adapted to provide a second weight signal indicative of the weight of the container when weighed by the second weighing device; and
a processor adapted to receive the first and second weight signals, the method including the steps of:
weighing a first container of the plurality of containers with the first weighing device to determine a first weight of the first container;
weighing the first container with the second weighing device to determining a second weight of the first container;
determining, using the processor, a calibration function that relates the second weight to an estimated weight;
weighing a second container of the plurality of containers with the second weighing device to determine a second weight of the second container;
determining, using the processor, the estimated weight of the second container based on the calibration function and the second weight.

Preferably, a number of second containers in the plurality of containers is larger than a number of first containers in the plurality of containers.

Preferably, the processor assigns a reliability score to the second weight based on a property of the second weighing device, wherein the reliability score alters an amount by which the second weight adjusts the calibration function.

Preferably, the first weighing device includes the assembly of the first aspect.

Preferably, the method further includes the step of:
moving the lifting structure to a calibrating position, wherein the movable actuators lift the lifting structure to an extension beyond the weighing position,
storing, using the processor, the load sensor signal in the calibrating position as a zero signal for calibration of the first weighing device.

Preferably, the extension of the movable actuators in the calibrating position is a maximum extension of the movable actuators.

Preferably, the method further includes the step of:
calibrating the first weighing device between each use of the first weighing device to determine the first weight of a container.

Preferably, the second weighing device includes a load sensor mounted on a lifting or transporting device for containers.

Preferably, the second weighing device is located more than 100 km away from the first weighing device.

### BRIEF DESCRIPTION OF DRAWINGS

Preferred embodiments of the present invention will now be described, by way of examples only, with reference to the accompanying drawings:

FIG. 1 shows an assembly for determining container weight according to a preferred embodiment of the invention.

FIG. 2 shows a detailed cut-away view of the assembly of FIG. 1.

FIG. 3 shows a detailed cut-away view of the assembly of FIG. 1.

FIG. 4 shows a detailed section view of the assembly of FIG. 1.

FIG. 5 shows a cut-away view of the assembly of FIG. 1.

FIG. 6 shows a flowchart of a method according to a preferred embodiment of the invention.

FIG. 7 shows a further flowchart of the method of claim FIG. 6.

FIG. 8 shows a further flowchart of the method of claim FIG. 6.

FIG. 9 shows a further flowchart of the method of claim FIG. 6.

FIG. 10 shows a flowchart of a method according to a further embodiment of the invention.

### DESCRIPTION OF EMBODIMENTS

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of documents or devices which form public knowledge through their respective publication and/or use. Such discussions should not be interpreted as a representation by the present inventor(s) or the patent applicant that such documents or devices in any way form part of the common general knowledge in the art.

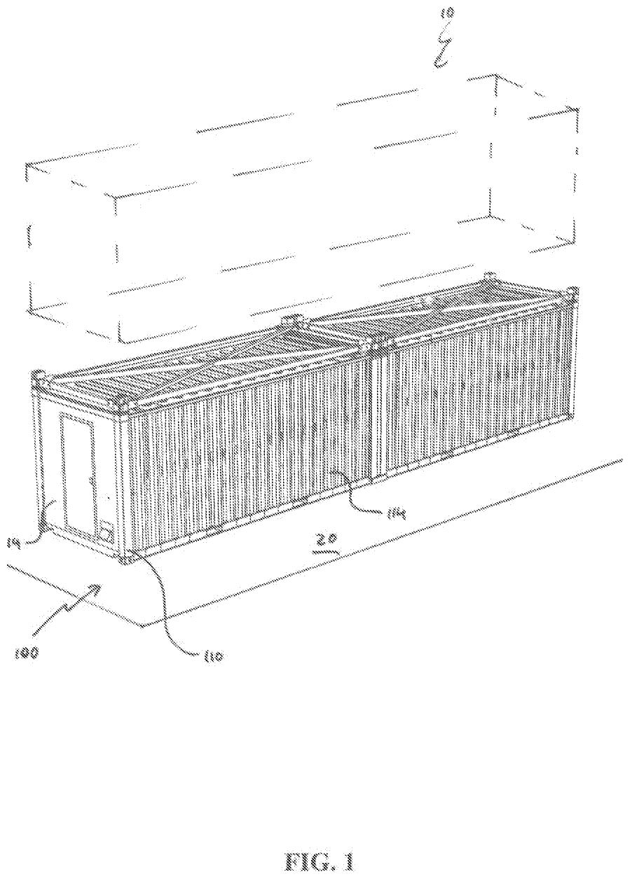

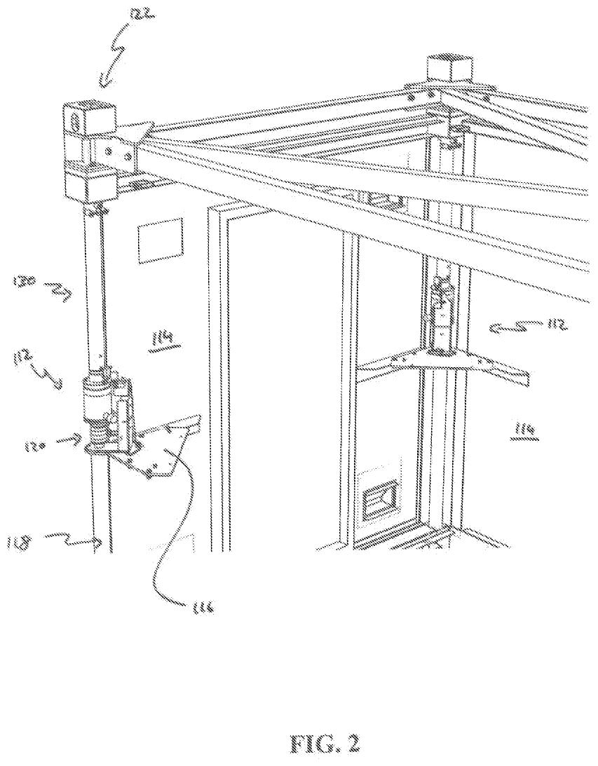

As seen in FIG. 1, a container lifting and weighing assembly 100 for determining a weight of a container 10 according to a preferred embodiment of the invention includes a frame 110 for supporting the container 10. The frame 110 is connectable to a support surface 20, such as a ground surface, to transfer the weight of the container 10 from the container to the support surface 20. Preferably, the frame 110 is dimensioned to match the footprint of a typical intermodal container, for example being a rectangle 12.01 m long and 2.35 m wide. Preferably, and as seen in FIG. 2, the frame 110 includes a support column 112 at each vertex. The frame 110 further includes sidewalls 114 extending between the vertices. Adjacent each support column 112, the frame 110 includes a stiffening member 116 extending from one sidewall 114 joining the vertex to the other sidewall 114 joining the vertex, and connected to the support column 112 so as to inhibit buckling of the support column 112.

Each support column 112 includes a fixed portion 118 extending toward the support surface 20. The fixed portion 118 includes a load sensor 120, for example a load cell, adapted to provide a load cell signal indicative of a compressive force applied to the load cell 120. Each fixed portion 118 further abuts a container support 122 of the frame 110, such that the weight of the container 10 is transferable from the container support 122 via the fixed portion 118 to the support surface 20.

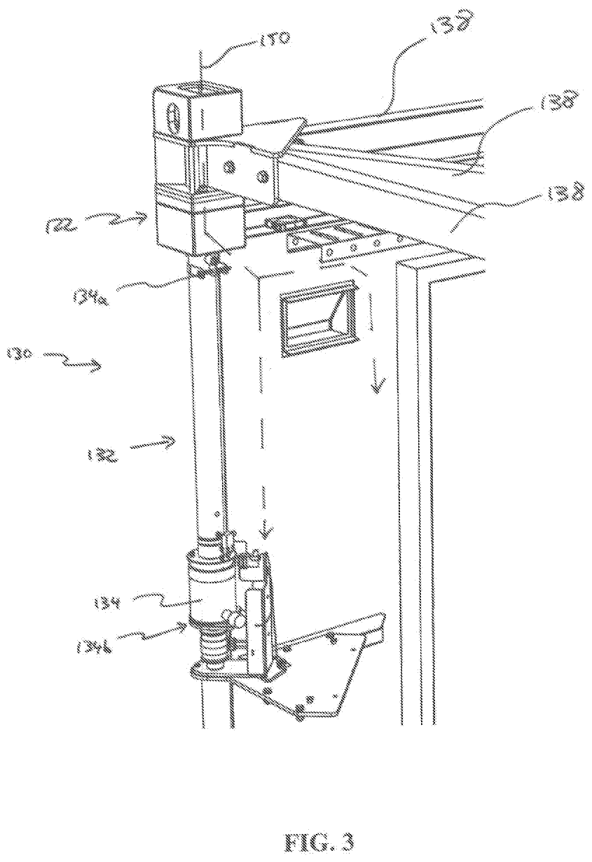

The assembly 100 further includes a lifting structure 130 locatable between the container 10 and the support surface 20. As seen in FIG. 3, the lifting structure 130 includes a movable portion 132. The movable portion 132 includes a movable actuator 134 connected to the container support 122 at a first end 134a. Preferably, the movable actuator 134 is a hydraulic actuator.

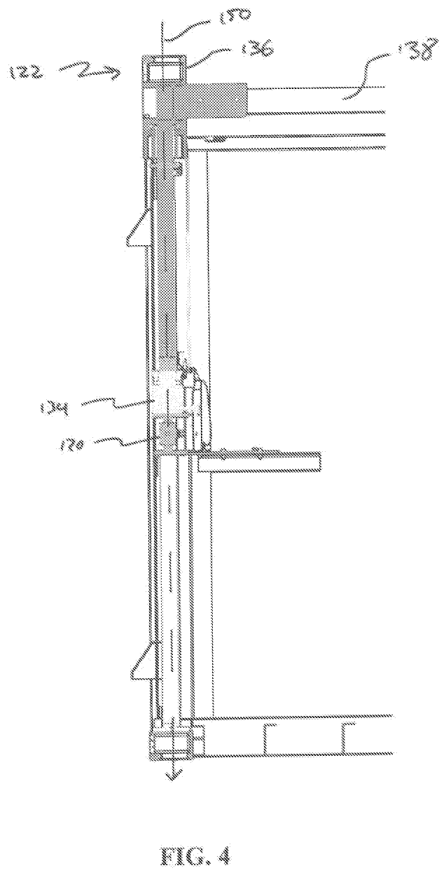

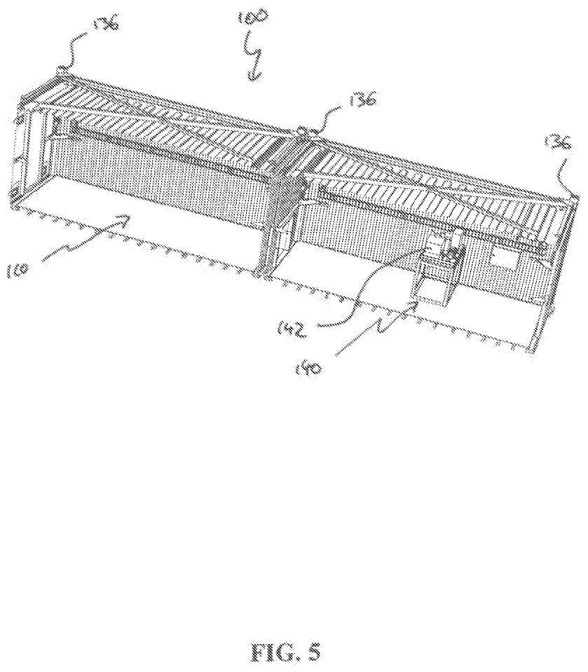

The movable actuator 134, and thereby the lifting structure 130, has a rest position, wherein a second end 134b does not bear weight and a load path 150 from the container 10 to the support surface 20 does not traverse the lifting structure 130. The movable actuator 134, and thereby the lifting structure 130, also has a weighing position, wherein the second end 134b abuts the load cell 120 and exerts a force on the load cell 120 such that the container 10 is lifted from the container support 112, such that the load path 150 from the container 10 to the support surface 20 traverses the lifting structure, more specifically the load cell 120, as seen in FIG. 4. In the weighing position, the load cell 120 is adapted to provide a load cell signal indicative of the weight of the container 10.

The lifting structure 130 preferably includes a corner casting 136 adjacent each movable actuator 134, such that the container 10 is locatable on or attached to the corner castings 136. Preferably, the lifting structure 130 includes a brace 138 extending between the corner castings 136.

The movable actuator 134, and thereby the lifting structure 130, further has a calibrating position, wherein the movable actuator 134 extends beyond the weighing position. Preferably, the calibrating position is a maximum extension of the movable actuator 134. The load cell signal provided by the load cell 120 in the calibrating position is defined as a zero signal. This calibrates the load cell against the weight of the lifting structure 130 born by the fixed portion 118 of the support columns, when the lifting structure 130 is moved to the calibrating position without a container 10.

In a preferred embodiment, the assembly 100, when the lifting structure 130 is in the rest position, has dimensions of (or slightly more than) 12.01 metres×2.35 metres×2.38 metres, such that the corner castings 136 are located in a position normally required of intermodal shipping containers by international standards. Preferably, a control unit 140 is located inside the frame 110 to control the movable actuator 134 and receive the weight signal at a processor 142. In another embodiment, the processor 142 is located off-site, or includes a cloud-based processing resource.

Use of the assembly 100 will now be discussed.

A typical port will include a number of items of container handling equipment, such as cranes, trucks, and lifters. These types of equipment are commonly equipped with weighing devices such as load cells. In further discussion, these weighing devices will be discussed as a second weighing device 220, they share the property that they are exposed to shock loads, when lifting and depositing the container 10, and the readings of the second weighing device 30 are therefore unreliable.

This disclosure thus contemplates a method of estimating the weight of a plurality of intermodal containers 10 using a weighing system 200. The weighing system 200 includes a first weighing device 210 adapted to provide a first weight signal indicative of a weight of the container 10 when weighed by the first weighing device 210. Preferably, the first weighing device 210 includes the assembly 100. The weighing system 200 further includes a second weighing 220 device, for example those found on container handling equipment, that is more likely to experience a shock load. The second weighing device 220 is also adapted to provide a second weight signal indicative of the weight of the container 10 when weighed by the second weighing device 220. The weighing system 200 further includes a processor 230 adapted to receive the first and second weight signals.

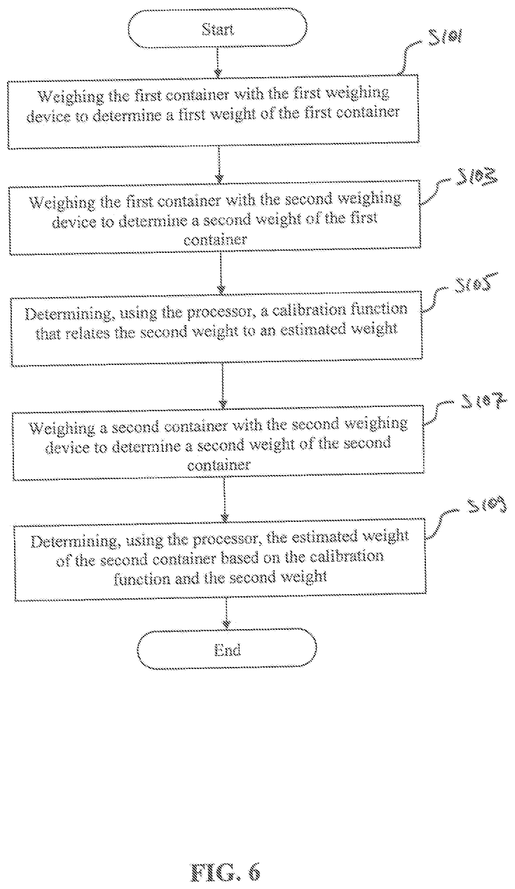

The method according to an embodiment of the invention begins, as shown in FIG. 6, at step S101 by weighing a first container 10 of the plurality of containers with the first weighing device 210 to determine a first weight of the first container 10. At step S103, the method continues by weighing the first container 10 with the second weighing device 220 to determining a second weight of the first container 10. At step S105, the processor 230, having received the first and second weight signals, determines a calibration function that relates the second weight to an estimated weight, wherein the estimated weight is substantially the same as the first weight, which is substantially the same as the actual weight of the first container 10.

The calibration function may be chosen based on characteristics of the second weighing device 220. For example, it may be known that a particular type of second weighing device loses calibration according to a polynomial function—in which case the processor will determine the corrective polynomial calibration function. In another example, the calibration function may include a neural network including the second weight as an input, the estimated weight as an output, and the first weight as a teaching data set. The latter example becomes more powerful when multiple second weighing devices 220 are used to determine multiple second weights of the container 10.

Following determination of the calibration function, the method continues at step S107 by weighing a second container 10 of the plurality of containers with the second weighing device 220 to determine a second weight of the second container 10. Finally, the method concludes by estimating, at step S109, using the processor 230, the estimated weight of the second container 10 based on the calibration function and the second weight. It will be understood that the processor 230 may be a locally networked, wide area networked, and/or have a cloud-based processing resource.

Typically, the number of second containers 10, i.e. containers 10 that are weighed only by the second weighing device 220, is larger than the number of first containers 10, i.e. containers 10 that are weighed by both the second weighing device 220 and the first weighing device 210. In one embodiment, the first weighing device 210 and the second weighing device 220 are geographically separated, for example by more than 100 km, or even more than 1000 km, as the container 10 is weighed, for example, by the first weighing device 210 at the loading port, and the second weighing device 220 at the unloading port. In another example, the container 10 is weighed by a plurality of second weighing device 220 in a variety of ports. To facilitate the use of the first weight to calibrate each second weighing device 220, the processor 230 stores each second weight using a unique container identification, such that if the container 10 is weighed by the first weighing device 210 at a later point, the earlier second weights may still be used to determine or adjust the calibration function.

In another example, the second weighing device 220, and all second weights determined by the second weighing device 220, may be assigned a reliability score by the processor 230. The processor 230 determines the reliability score on a variety of factors including how quickly the calibration function for the second weighing device 220 drifts from a known position (i.e. how large the correction is every time the processor 230 adjusts the calibration function for that second weighing device 220), the spread of estimated weights produced by the calibration function compared to first weights measured for that second weighing device 220, and a predetermined score adjustment based on experience with that equipment. If the reliability score assigned to a second weighing device 220 is sufficiently high, the processor 230 may treat that second weighing device 220 as a first weighing device 210. The processor 230, when adjusting the calibration function, may rely on the first weights provided by the first weighing devices 210 to different amounts on the basis of their reliability score, for example by applying a weight to each first weight based on the reliability score.

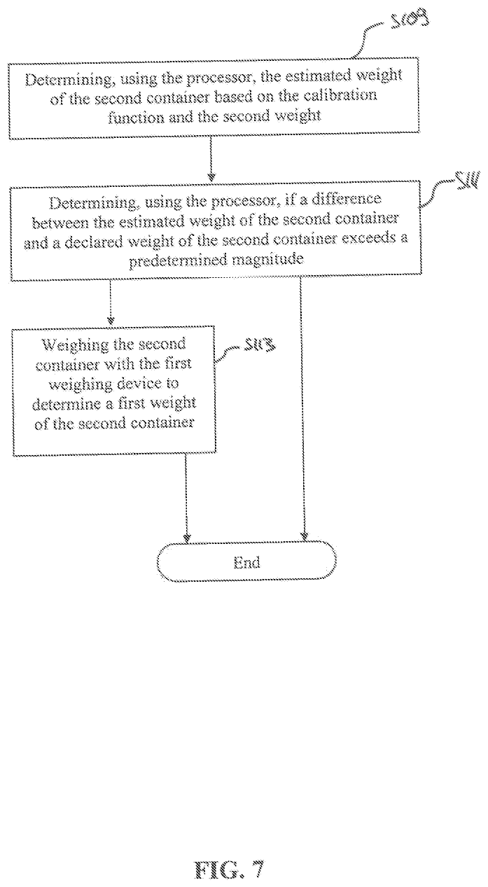

In one embodiment, as shown in FIG. 7, the method may continue at step S111 by determining, using the processor 230, if a difference between the estimated weight and a declared weight exceeds a predetermined magnitude. At step S113, if the difference exceeds the predetermined magnitude, the second container 10 is weighed with the first weighing device 210 to determine a first weight.

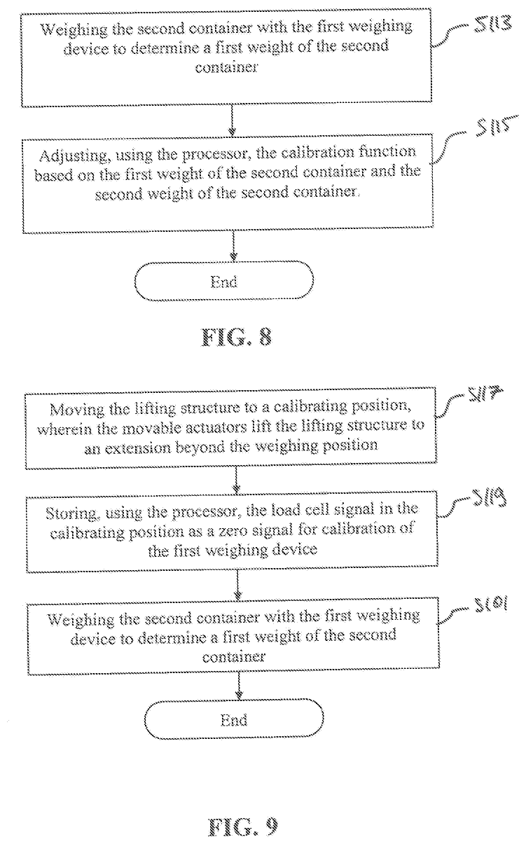

Optionally, after step S113 and as shown in FIG. 8, the processor 230 may at step S115 adjust the calibration function based on the first weight of the second container 10 determined by the first weighing device 210 and the second weight of the second container 10 determined by the second weighing device 220.

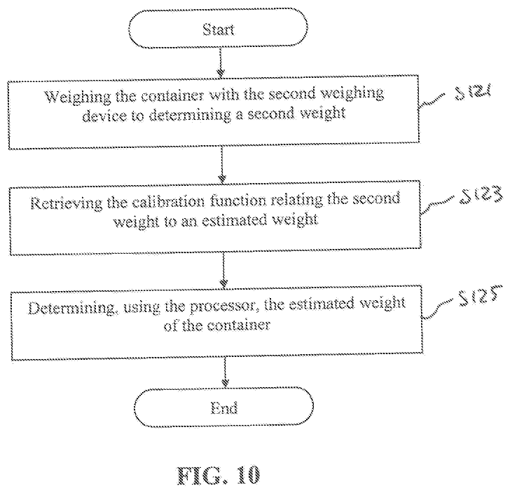

The first weighing device 210 is kept in calibration by moving the lifting structure 130 to the calibrating position, as shown in FIG. 9. Preferably, the calibration step S117 is performed before, or between, each use of the first weighing device 210. The calibration step S117 includes moving the lifting structure 130 to the calibrating position such that the lifting structure 130 is moved to a, preferably maximum, extension beyond the weighing position. At step S119 the processor 230 stores the load cell signal in the calibrating position as a zero signal for calibration of the first weighing device 210. Therefore, the processor 230 may interpret the first weighing signal relative to the zero signal to obtain an accurate determination of the weight of the container 10 being weighed.

In another embodiment, the calibration function may already be known, or pre-exist. In this embodiment, as shown in FIG. 10, the weight of the container may be estimated by commencing at step S121 with weighing the container 10 with the second weighing device 220 to determine a second weight. At step S123 the processor 230 retrieves the calibration function that relates the second weight to an estimated weight from memory or an off-site data storage location. At step S125, the processor determines, based on the calibration function that relates the second weight to an estimated weight, the estimated weight of the container 10. Due to the calibration function, the estimated weight is closer to an actual weight of the container 10 than the second weight.

Steps S111, S113, S115, S117, and S119 may also optionally be performed in this embodiment.

Advantages of the assembly 100 will now be discussed.

Because the assembly 100 has a rest position in which the load path 150 does not traverse the lifting portion 130, and more particularly does not traverse the load cell 120, the load cell 120 is not exposed to shock loads when the container 10 is deposited on the assembly 100. The absence of shock loads greatly improves the accuracy of the load cell 120, and reduces the tendency of the load cell 120 to fall out of calibration.

The use of the movable actuators 134 and the lifting structure 130 as a calibrating weight in the calibrating position allow the assembly 100 to be calibrated between each use.

The dimensions of the assembly 100 to match the footprint and/or volume of an intermodal container allow the assembly 100 to be moved as if it were a container.

The determination of a calibration function relating the second weight to an estimated weight allows the use of the second weighing device 220 as a sorting device to determine which containers should be weighed by the more accurate first weighing device 210, or to provide a statistically significant estimate of the overall weight of a plurality of containers 10.

The determination whether a declared weight is different to the estimated weight of a container 10 allow the container 10 to be targeted for accurate weighing, resulting in a potential income flow of over-weight and/or under-weight fees. Additionally, overdeclared containers may be identified potentially resulting in better utilisation of a container vessel.

Continuous adjustment of the calibration function on the basis of the first weights determined by the first weighing device 210 keep the calibration function accurate.

Estimating the weight of a container on the basis of the calibration function provide an statistically significant estimate of a container, or a plurality of containers, without the use of unnecessary handling time. Testing a subset of the plurality of containers using the first weighing device allows spot testing and maintenance of the calibration function. Calibrating the first weighing device 210 between each use improves calibration consistency of the first weighing device 210.

Although the invention has been described with reference to a preferred embodiment, it will be appreciated by those skilled in the art that the invention may be embodied in other forms.

The advantageous embodiments and/or further developments of the above disclosure—except for example in cases of clear dependencies or inconsistent alternatives—can be applied individually or also in arbitrary combinations with one another.

1.-20. (canceled)

21. A container lifting and weighing assembly for determining a weight of a container, the assembly having:
a frame for supporting a container, the frame being connectable to a support surface to transfer a weight of the container from the container to the support surface;
a lifting structure locatable between the container and the support surface, the lifting structure having one or more movable actuators and a load sensor, the lifting structure being movable between:
a rest position, wherein the load path from the container to the support surface does not traverse the lifting structure; and
a weighing position, wherein the lifting structure lifts the container such that the load path from the container to the support surface traverses the lifting structure,
wherein, in the weighing position, the load sensor is adapted to provide a load sensor signal indicative of the weight of the container.

22. The assembly of claim 21, wherein the lifting structure is further movable to and from:
a calibrating position, wherein the movable actuators lift the lifting structure to an extension beyond the weighing position,
wherein the load sensor signal in the calibrating position is a zero signal.

23. The assembly of claim 22, wherein the extension is a maximum extension of the movable actuator.

24. The assembly of claim 21, wherein the movable actuators include hydraulic actuators.

25. The assembly of claim 21, wherein the assembly, when the lifting structure is in the rest position, has dimensions of at least 12.01 metres×2.35 metres×2.38 metres.

26. The assembly of claim 21, wherein the assembly has dimensions of about 12.01 metres length and 2.35 metres width.

27. A method of estimating a weight of an intermodal container using a weighing system, the weighing system including:
a second weighing device that is more likely to experience a shock load and is adapted to provide a second weight signal indicative of the weight of the container when weighed by the second weighing device; and
a processor adapted to receive the first and second weight signals,
the method including the steps of:
weighing the container with the second weighing device to determine a second weight; and
determining, using the processor, based on a calibration function that relates the second weight to an estimated weight, the estimated weight,
wherein the estimated weight is closer to an actual weight of the container than the second weight.

28. The method of claim 27, wherein the weighing system further includes:
a first weighing device adapted to provide a first weight signal indicative of a weight of the container when weighed by the first weighing device,
and wherein the method further includes the steps of:
determining, using the processor, if a difference between the estimated weight of the second container and a declared weight of the second container exceeds a predetermined magnitude; and
if the difference exceeds the predetermined magnitude, weighing the second container with the first weighing device to determine a first weight.

29. The method of claim 28, wherein the method further includes the step of:
adjusting, using the processor, the calibration function based on the first weight of the second container determined by the first weighing device and the second weight of the second container determined by the second weighing device.

30. The method of claim 28, wherein the first weighing device includes the assembly of claim 1.

31. The method of claim 30, wherein the method further includes the step of:
moving the lifting structure to a calibrating position, wherein the movable actuators lift the lifting structure to an extension beyond the weighing position; and
storing, using the processor, the load sensor signal in the calibrating position as a zero signal for calibration of the first weighing device.

32. The method of claim 30, wherein the extension of the movable actuators in the calibrating position is a maximum extension of the movable actuators.

33. The method of claim 28, wherein the method further includes the step of:
calibrating the first weighing device between each use of the first weighing device to determine the first weight of a container.

34. The method of claim 27, wherein the second weighing device includes a load sensor mounted on a lifting or transporting device for containers.

35. The method of claim 28, wherein the second weighing device is located more than 100 km away from the first weighing device.

36. A method of estimating a weight of a plurality of intermodal containers using a weighing system, the weighing system including:
a first weighing device adapted to provide a first weight signal indicative of a weight of the container when weighed by the first weighing device;
a second weighing device that is more likely to experience a shock load and is adapted to provide a second weight signal indicative of the weight of the container when weighed by the second weighing device; and
a processor adapted to receive the first and second weight signals,
the method including the steps of:
weighing a first container of the plurality of containers with the first weighing device to determine a first weight of the first container;
weighing the first container with the second weighing device to determining a second weight of the first container;
determining, using the processor, a calibration function that relates the second weight to an estimated weight;
weighing a second container of the plurality of containers with the second weighing device to determine a second weight of the second container; and
determining, using the processor, the estimated weight of the second container based on the calibration function and the second weight.

37. The method of claim 36, wherein a number of second containers in the plurality of containers is larger than a number of first containers in the plurality of containers.

38. The method of claim 36, wherein the method further includes the steps of:
determining, using the processor, if a difference between the estimated weight of the second container and a declared weight of the second container exceeds a predetermined magnitude; and
if the difference exceeds the predetermined magnitude, weighing the second container with the first weighing device to determine a first weight of the second container.

39. The method of claim 38, wherein the method further includes the step of:
adjusting, using the processor, the calibration function based on the first weight of the second container determined by the first weighing device and the second weight of the second container determined by the second weighing device.

40. The method of claim 39, wherein the processor assigns a reliability score to the second weight based on a property of the second weighing device, wherein the reliability score alters an amount by which the second weight adjusts the calibration function.

41. The method of claim 36, wherein the first weighing device includes the assembly of claim 1.

42. The method of claim 41, wherein the method further includes the steps of:
moving the lifting structure to a calibrating position, wherein the movable actuators lift the lifting structure to an extension beyond the weighing position; and
storing, using the processor, the load sensor signal in the calibrating position as a zero signal for calibration of the first weighing device.

43. The method of claim 41, wherein the extension of the movable actuators in the calibrating position is a maximum extension of the movable actuators.

44. The method of claim 36, wherein the method further includes the step of:
calibrating the first weighing device between each use of the first weighing device to determine the first weight of a container.

45. The method of claim 36, wherein the second weighing device includes a load sensor mounted on a lifting or transporting device for containers.

46. The method of claim 36, wherein the second weighing device is located more than 100 km away from the first weighing device.
